(19) United States
(12) Patent Application Publication
(10) Pub. No.: US 2026/0243111 A1
(43) Pub. Date: Aug. 20, 2026

(54) MOTOR VEHICLE LOCKING DEVICE

(71) Applicant: Kiekert Aktiengesellschaft, Heiligenhaus (DE)

(72) Inventor: Tobias KLOCKE, Mettmann (DE)

(73) Assignee: Kiekert Aktiengesellschaft, Heiligenhaus (DE)

(21) Appl. No.: 18/876,754

(22) PCT Filed: May 24, 2023
(86) PCT No.: PCT/DE2023/100382

§ 371 Date: Dec. 19, 2024

(30) Foreign Application Priority Data
Jun. 24, 2022 (DE) 10 2022 115 829.2

(51) Int. Cl. E05B 81/06; E05B 81/14; E05B 81/90

(52) U.S. Cl. CPC E05B 81/06; E05B 77/12; E05B 81/14; E05B 81/80; E05B 81/82; E05B 81/86; E05B 81/90; E05B 2047/0013; E05Y 2400/612; E05Y 2400/852; E05Y 2900/531

(57) ABSTRACT

The invention relates to a motor vehicle locking device, in particular a motor vehicle lock and preferably a motor vehicle door lock. The motor vehicle locking device has a locking mechanism (1, 2) which consists substantially of a rotary latch (1) and a pawl (2). Furthermore, an electric motor drive (4, 5, 6, 7) is provided for opening the locking mechanism (1, 2). Moreover, an emergency opening device (9, 10, 11, 12, 13, 14) is provided for opening the lock (1, 2) in the event of an emergency manually and/or using a motor. The emergency opening device (9, 10, 11, 12, 13, 14) is equipped with at least one electronic control unit (14) for evaluating at least one emergency opening signal. According to the invention, the control unit (14) of the emergency opening device (9, 10, 11, 12, 13, 14) is designed as an application-specific integrated circuit (14) or ASIC.

The invention relates to a motor vehicle locking device, in particular a motor vehicle lock and preferably a motor vehicle door lock, with a locking mechanism consisting substantially of a catch and a pawl, furthermore with an electric motor drive for opening the locking mechanism, and with an emergency opening device for manual and/or motorized emergency opening of the locking mechanism, wherein the emergency opening device is equipped with at least one electronic control unit for evaluating at least one emergency opening signal.

Motor vehicle locking devices, and in particular motor vehicle locks, usually have a so-called servo opening for reasons of convenience. This is implemented with the help of an electric motor drive, which opens the locking mechanism. For this purpose, the electromotive drive works directly or indirectly on the pawl as part of the locking mechanism and lifts it from its latching engagement with the catch. As a result of this, the catch can open with the assistance of a spring and can release a previously captive locking bolt.

The basic problem with such servo locks is that the locking mechanism cannot (or can no longer) be opened in this manner if the on-board power supply voltage is too low or if the on-board power supply voltage or the electric motor drive fails. Emergency opening devices are provided for this purpose. Such an emergency opening device is described in the generic prior art according to WO 2019/076402A1. In fact, a operating lever chain is realized at this point, which is directly or indirectly blocked in normal operation and released for emergency opening. For this purpose, a control member is realized, which is equipped with an electric motor and an output element. The electric motor is activated in response to signals from a sensor, in particular a crash sensor.

The control member interacts directly with a lever of the operating lever chain. The control member is also arranged in the area of an external operating lever as part of an external operating lever chain. Depending on the signals from the crash sensor, this allows the operating lever chain or external operating lever chain to be released as required for emergency opening using the control member. This has proven to be fundamentally successful.

However, there is room for improvement here. This is because the signals from the crash sensor are evaluated using a control unit, which in turn is supplied by the vehicle electrical system voltage. This means that any problems with the power supply to the vehicle electrical system may also mean that the emergency opening function cannot be performed or can no longer be performed correctly. In addition, the known control unit is integrated into the overall control architecture of the associated motor vehicle. This means that any software errors, indifferent functional states etc. in conjunction with a low vehicle electrical system voltage can lead to the emergency opening failing, although this would be possible in principle. This is unacceptable, especially in the event of a crash or if the on-board power supply fails or is too low, especially as this also reduces overall comfort. This is where the invention aims to provide a remedy.

The invention is based on the technical problem of further developing such a motor vehicle locking device in such a manner that a particularly functional and preferably self-sufficient operation of the emergency opening device is provided.

To solve this technical problem, the invention proposes that the control unit of the emergency opening device is designed as an application-specific integrated circuit (ASIC) in a motor vehicle locking device of the same type.

In contrast to the generic prior art according to WO 2019/076402A1, the invention thus makes use of a specific control unit for the emergency opening device, namely an application-specific integrated circuit. This is an integrated circuit whose function can no longer be changed after manufacture. This means that subsequent reprogramming or new programming is expressly not possible. Rather, the application-specific integrated circuit in question is manufactured according to customer requirements and delivered in this form. The customer requirements may be, for example, requirements as to which additional signals are to be evaluated by the application-specific integrated circuit for emergency opening, which signal thresholds are to be observed, etc.

In fact, the application-specific integrated circuit is advantageously equipped with at least one sensor in accordance with the invention. This sensor can be a sensor integrated into the circuit. For example, the sensor may be designed as a touch sensor, which consequently initiates the emergency opening. Of course, it is also conceivable to use other sensors in this context, for example a movement sensor, a switch, etc. instead of the touch sensor. In addition, different response thresholds can be defined for the touch sensor.

The adaptation to the desired sensor, its response threshold etc. is now customer-specific and according to customer requirements, i.e. it can be individually specified for each motor vehicle locking device and can no longer be changed after installation and manufacture by using the application-specific integrated circuit according to the invention. This means, for example, that any actuation thresholds for the touch sensor during emergency opening are predefined once and for all and cannot (or can no longer) be changed at a later date.

By using the application-specific integrated circuit (ASIC) according to the invention, on the other hand, low manufacturing costs are observed for the circuit in question and, on the other hand, changes-as described-are no longer possible after installation. In particular, the application-specific integrated circuit as the control unit of the emergency opening device is designed to be independent of the remaining network structure of the motor vehicle and the software used there, as well as an additional control apparatus or an additional control unit implemented on the vehicle side. Due to this self-sufficient character, the emergency opening device is ultimately separated from the rest of the vehicle in terms of its mode of operation according to the invention. As a result, the application-specific integrated circuit as the control unit of the emergency opening device can be supplied with a lower voltage than the vehicle electrical system voltage, for example. This means that the application-specific circuit has its own energy supply. This own energy supply can be an energy store.

However, the energy store is advantageously designed as a battery, although other energy stores such as capacitors, in particular high-performance capacitors, can also be used here. As a result of this and by relying on its own energy supply, the functionality of the emergency opening device according to the invention is not affected in particular by the fact that, for example, the vehicle electrical system of the associated motor vehicle has too low a voltage or no voltage at all. Rather, the emergency opening device according to the invention, in conjunction with the application-specific integrated circuit and its own energy supply, is able to ensure proper emergency opening even in such a case. These are the main advantages.

Application-specific integrated circuits are already used in the motor vehicle sector and also in connection with motor vehicle locks in the prior art, as the KR 101233817 B1 or the KR 101307916 B1 make clear. However, this is neither an opening process nor an emergency opening process. The same applies to DE 10 2013 004 178 A1, which describes a locking system for a motor vehicle. In the course of authentication and the realization of an electronic key, an integrated circuit in the form of an ASIC is used. This has nothing to do with the emergency opening and the specifically modified emergency opening device according to the invention.

According to a further advantageous embodiment, at least one additional control unit is provided on the vehicle side. In addition, the application-specific integrated circuit has at least one sensor, which can be integrated into the circuit. In addition, a relay is usually provided downstream of the application-specific integrated circuit. The relay can be used to control a motor for emergency opening. This means that a low voltage and low energy from the emergency opening device is sufficient to actuate the relay, which in turn switches on the motor for emergency opening.

In principle, the control unit of the emergency opening device in the form of the application-specific integrated circuit used according to the invention can also be connected to the vehicle electrical system as an alternative or in addition to its own energy supply. For example, it is conceivable that the emergency opening device's own energy supply could be provided by an energy store in the form of an accumulator. This accumulator may in turn be charged regularly using the on-board electrical system of the motor vehicle.

As a rule, however, the emergency opening device according to the invention is equipped with its own energy supply and at this point advantageously with its own and separate battery in order to ensure the functionality of the emergency opening device—independent of the vehicle electrical system—in any case.

In addition, the sensor assigned to the application-specific integrated circuit makes it possible, for example, to operate vehicle doors without a handle or so-called handleless doors. In this case, the emergency opening device may ensure that, for example, a recessed handle is displayed, an additional hook for gripping the doors is visible, etc.

In addition, the application-specific circuit can also be equipped with its own fault diagnostics. In connection with this fault diagnosis, it is conceivable that the emergency opening device sends a corresponding signal to the higher-level control unit on the vehicle side when a fault occurs. The signal in question may be a pulsed signal, for example a PWM signal (pulse width modulated signal). As a result, the control unit on the vehicle side can subsequently issue an error message on a display, for example, indicating that the emergency opening device is faulty or has a fault itself.

Finally, the emergency opening device according to the invention is advantageously equipped with a transmitter/receiver unit. Like the sensor, this sender/receiver unit can be embedded in the application-specific integrated circuit or form part of it. A supplementary authentication check can be carried out using the sender/receiver unit. With the help of this authentication check in the sense of a “key exchange”, it is possible and conceivable for an operator to additionally identify himself as authorized to the emergency opening device.

As a rule, data is exchanged between an operator-side key and the sender/receiver unit in question, which is embedded or integrated in the application-specific integrated circuit according to the invention. In the course of this data exchange, an authorization check of the key and thus of the operator is carried out. This ensures that only an authorized operator can actually trigger the emergency opening device and ensure the desired emergency opening of the associated motor vehicle door.

The emergency opening device according to the invention can basically be designed as a module, i.e. as an independent functional unit which is assigned to the associated motor vehicle locking device independently of the latter. The modular character of the emergency opening device realized according to the invention can be further emphasized and enhanced by the fact that the application-specific integrated circuit, including sensor and sender/receiver unit, defines an installation module as a whole. This built-in module can basically do without its own circuit board. In principle, however, an additional circuit board is also possible. In any case, the application-specific integrated circuit, including the energy store and optional other elements such as the sensor and sender/receiver unit, can generally be combined to form a module, which is housed in its own housing, for example, or forms a ready-to-install element with the aid of an insulating potting compound. This separate module can be placed directly inside a housing for the motor vehicle locking device, but can also be flange-mounted to the outside of the housing in question. The energy-autonomous nature of the emergency opening device according to the invention and its decoupling from the vehicle's control unit ensure a high level of functional reliability. This functional reliability is also maintained for practically the entire life of the vehicle and is guaranteed regardless of whether or not any software updates are made to the vehicle's control unit. These are the main advantages.

In the following, the invention is explained in more detail with the aid of a drawing showing only an exemplary embodiment; in the figures:

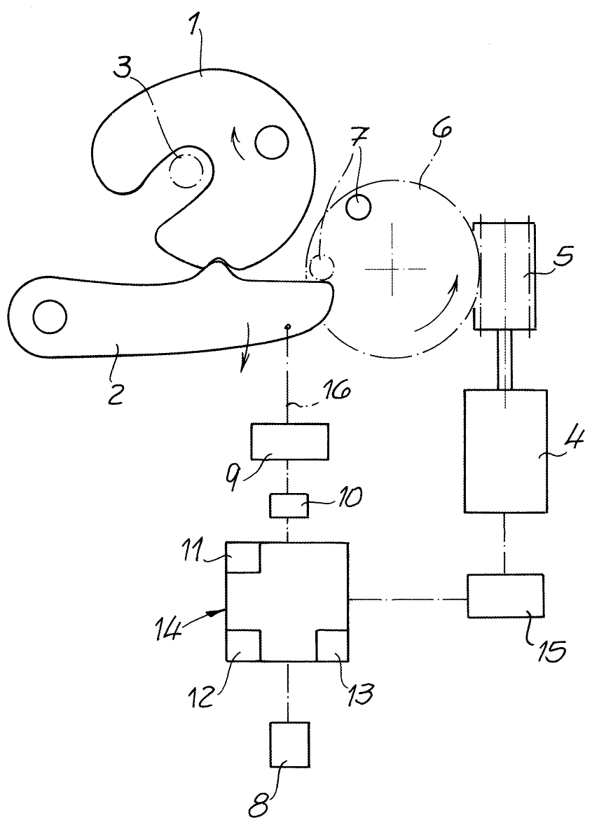

FIG. 1 shows a schematic overview of the motor vehicle locking device according to the invention in the form of a motor vehicle lock and, in particular, a motor vehicle door lock.

FIG. 1 shows a motor vehicle locking device in the form of a motor vehicle lock or motor vehicle door lock. For this purpose, the motor vehicle locking device has a locking mechanism 1, 2 consisting substantially of a catch 1 and an associated pawl 2. The pawl 2 is used to lock the catch 1 in a closed position. To open the locking mechanism 1, 2, it is necessary to swivel the pawl 2 around its axis in the indicated clockwise direction according to the exemplary embodiment. As a result, the catch 1 is released from the pawl 2 and can also open in a clockwise direction with spring support. A previously captured locking bolt 3 is released in this manner. This allows the associated vehicle door to be opened.

According to the exemplary embodiment, an electric motor drive 4, 5, 6, 7 opens the locking mechanism 1, 2. The electric motor drive 4, 5, 6, 7 in turn has an electric motor 4, which rotates an output-side worm 5. The output-side worm 5 engages in a worm wheel 6 and ensures that the worm wheel 6 rotates counterclockwise to open the locking mechanism 1, 2 according to the exemplary embodiment. As a result of this, a pin 7 connected to the worm wheel 6 can move against the locking pawl 2 and pivot it in the indicated clockwise direction, so that the locking mechanism 1, 2 is then opened as described.

In addition to this described servo-opening of the locking mechanism 1, 2 using the electromotive drive 4, 5, 6, 7, emergency opening of the locking mechanism 1, 2 is also possible. Such an emergency opening is required and necessary, for example, if a crash sensor 8 generates a corresponding crash signal. This crash signal regularly corresponds to accelerations or decelerations of the motor vehicle that exceed several g. As a rule, however, the locking mechanism 1, 2 is opened in an emergency if the electric motor drive 4, 5, 6, 7 has failed or if the on-board power supply provided for the electric motor drive 4, 5, 6, 7 is not sufficient to operate it or is no longer available.

In fact, an emergency opening device 9, 10, 11, 12, 13, 14 is realized at this point. The emergency opening device 9, 10, 11, 12, 13, 14 is capable of manual and/or motorized emergency opening of the locking mechanism 1, 2. This is explained in more detail below. For this purpose, the emergency opening device 9, 10, 11, 12, 13, 14 firstly and substantially has an electronic control unit 14, with the aid of which at least one emergency opening signal is evaluated or can be evaluated. The emergency opening signal may be a signal from the previously mentioned crash sensor 8, which is connected to the control unit 14 in question for this purpose.

As a rule, however, the emergency opening signal for the control unit 14 comes from a sensor 12, which is activated by an operator to initiate the emergency opening. According to the exemplary embodiment, the sensor 12 is a sensor 12 integrated into the electronic circuit or the electronic control unit 14. In fact, according to the exemplary embodiment, the sensor 12 is designed as a touch sensor 12. In principle, however, the sensor 12 can also be any other sensor, such as a switch or similar.

According to the invention and of particular importance is the fact that the control unit 14 as a component of the emergency opening device 9, 10, 11, 12, 13, 14 is designed as an application-specific integrated circuit or AS IC. As a result, all functions of the control unit 14 are defined by the manufacturer and expressly cannot be changed (any more) after manufacture and installation, for example in the form of a software update. This has already been explained in the introduction.

According to the exemplary embodiment, the application-specific integrated circuit or the control unit 14 of the emergency opening device 9, 10, 11, 12, 13, 14 according to the invention has its own energy supply. The energy supply is designed as an energy store 11. The energy store 11 is an integrated battery 11. This battery 11 can be designed as an accumulator and can be charged at regular intervals via a connected vehicle electrical system, for example. As a rule, however, it is a non-rechargeable battery, so that the emergency opening device 9, 10, 11, 12, 13, 14 is designed overall as an independent functional unit or module and can consequently be attached to or in a housing of an associated motor vehicle locking device. Due to the self-sufficient design of the emergency opening device 9, 10, 11, 12, 13, 14, for example, software updates of a control unit 15, which is usually additionally provided on the vehicle side, do not play a role or the functioning of the emergency opening device 9, 10, 11, 12, 13, 14 is not affected by this.

The basic structure of the emergency opening device 9, 10, 11, 12, 13, 14 includes not only the control unit 14, which is designed as an application-specific integrated circuit 14. In addition to the previously mentioned sensor 12 and the battery or energy store 11, a relay 10 and a motor 9 are also implemented. The relay 10 can be used to control the motor 9 in order to lift the pawl 2 from its engagement with the catch 3 during emergency opening. For this purpose, the motor 9 may operate on a mechanical intermediate link 16, with the aid of which the motor 9 is connected to the pawl 2. This may be a Bowden cable.

In principle, however, the emergency opening device 9, 10, 11, 12, 13, 14 can also be set up for manual emergency opening of the locking mechanism 1, 2. In this case, motor 9 is not required. The manual emergency opening of the locking mechanism 1, 2 is then accomplished using the emergency opening device 9, 10, 11, 12, 13, 14 in such a manner that, following an emergency opening signal registered, for example, by the sensor 12, a mechanical connection is realized via the relay 12, for example, between a handle implemented instead of the motor 9 and the pawl 2 with the intermediate link 16. This means that in this case the emergency opening device 9, 10, 11, 12, 13, 14 ensures that the handle is mechanically connected to the intermediate link 16 and thus to the pawl 2, so that the pawl 2 can be removed from its engagement with the catch 3 via the handle in the course of the emergency opening.

Another component of the emergency opening device 9, 10, 11, 12, 13 is a sender/receiver unit 13. The sender/receiver unit 13 may be integrated into the control unit 14 in the same way as the sensor 12 and the energy store 11. The same applies to relay 10. This provides a compact and practically ready-to-install module 10, 11, 12, 13, into which the motor 9 can also be integrated.

An authentication check is carried out using the sender/receiver unit 13. For this purpose, data is exchanged between the sender/receiver unit 13 and an operator-side key, which is not shown. In the course of this data exchange, the authorization of the key and thus of the operator is checked to ensure that only an authorized operator can perform the emergency opening of locking mechanism 1, 2.

The control unit 14 or the application-specific integrated circuit 14 is also connected to the control unit 15 on the vehicle side.

This connection ensures that, for example, any faults that occur in the emergency opening device 9, 10, 11, 12, 13, 14 can be transmitted to the control unit 15 and displayed there. Data may be exchanged via pulsed signals, for example a PWM signal (pulse width modulated signal). Of course, this only applies as an example and is by no means restrictive.

### LIST OF REFERENCE SIGNS

1 rotary latch
2 pawl
1,2 locking mechanism
4 electric motor
5 output-side worm
6 worm wheel
7 pin
4, 5, 6, 7 electromotive drive
8 crash sensor
9 motor
10 relay
11 energy store
12 touch sensor
13 sender/receiver unit
14 electronic control unit
9, 10, 11, 12, 13,14 emergency opening device
15 control unit on the vehicle side
16 intermediate link

1. A motor vehicle locking device, comprising:
a locking mechanism having a catch and a pawl,
an electric motor drive for opening the locking mechanism, and
an emergency opening device for at least one of manual emergency opening of the locking mechanism and/or motorized emergency opening of the locking mechanism,
wherein the emergency opening device is equipped with at least one electronic control unit for evaluating at least one emergency opening signal,
wherein the at least one electronic control unit of the emergency opening device is application-specific integrated circuit.

2. The motor vehicle locking device according to claim 1, wherein the emergency opening device includes an energy supply that is configured to power the application-specific integrated circuit.

3. The motor vehicle locking device according to claim 2, wherein the energy supply is an energy store.

4. The motor vehicle locking device according to claim 3, wherein the energy store includes at least one of an accumulator, a battery, and a high-performance capacitor.

5. The motor vehicle locking device according to claim 1, further comprising an external control unit positioned on a vehicle side of the motor vehicle locking device.

6. The motor vehicle locking device according to claim 1, wherein the application-specific integrated circuit comprises at least one sensor.

7. The motor vehicle locking device according to claim 6, wherein the at least one sensor is integrated in the application-specific integrated circuit.

8. The motor vehicle locking device according to claim 1, wherein the application-specific integrated circuit includes a downstream relay.

9. The motor vehicle locking device according to claim 8, further comprising a motor, wherein the downstream relay is configured to control the motor for the emergency opening.

10. The motor vehicle locking device according to claim 1, wherein the emergency opening device includes a sender and/or receiver unit for authentication checking.

11. The motor vehicle locking device according to claim 5, wherein the application-specific integrated circuit is configured to transmit a faulty signal to the external control unit when there is any fault in the emergency opening device.

12. The motor vehicle locking device according to claim 7, wherein the at least one sensor integrated in the application-specific integrated circuit is a touch sensor.

13. A motor vehicle locking device according to claim 1, further comprising a crash sensor configured to generate the least one emergency opening signal and send the generated emergency opening signal to the emergency opening device.
